(19) United States
(12) Patent Application Publication
(10) Pub. No.: US 2006/0117625 A1
(43) Pub. Date: Jun. 8, 2006

(54) Weather resistant segmented sign system

(75) Inventor: Diane L. Peterson, Addison, TX (US)

Correspondence Address: THORPE NORTH & WESTERN, LLP., 8180 SOUTH 700 EAST, SUITE 200, SANDY, UT, 84070, US

(73) Assignee: Atitania Ltd.

(21) Appl. No.: 11/003,708

(22) Filed: Dec. 3, 2004

(51) Int. Cl. G09F 7/10

(52) U.S. Cl. 40/611.01

(57) ABSTRACT

A method for protecting an advertising sign from weathering conditions is disclosed. The method includes the operation of providing a frame configured to hold a plurality of sign segments, the sign segments having a front side and a back side each configured to carry graphical images. The front and back sides of each sign segment can be covered with a substantially transparent covering configured to enable each sign segment to be essentially undamaged by weathering effects for a period of at least seven years. The plurality of sign segments can be configured to be stacked on top of one another within the frame. The frame can be configured to enable removal and replacement of one or more of the plurality of sign segments.

### BACKGROUND

Outdoor and indoor advertising is commonly used to advertise businesses, current events, sales, and other information. Sign systems can range from complex neon signs over one hundred feet tall in Las Vegas to stock paper advertising a yard sale and taped to a phone poll. While there is a well developed market for complex signs, the lower end market still typically remains a do-it-yourself project.

Current inexpensive signs available on the market can quickly become illegible due to the effects of weather. Even more expensive methods for producing signs, such as screen printing, can look worn in just a few months due to the effects of rain, wind, dust, and ultraviolet light. For small businesses, home businesses, and entrepreneurs, a need remains for signs which can be inexpensively constructed and maintained and which are substantially resistant to the effects of weather.

### SUMMARY

A method for protecting an advertising sign from weathering conditions is disclosed. The method includes the operation of providing a frame configured to hold a plurality of sign segments, the sign segments having a front side and a back side each configured to carry graphical images. The front and back sides of each sign segment can be covered with a substantially transparent covering configured to enable each sign segment to be essentially undamaged by weathering effects for a period of years. The plurality of sign segments can be configured to be stacked on top of one another within the frame. The frame can be configured to enable removal and replacement of one or more of the plurality of sign segments.

### BRIEF DESCRIPTION OF THE DRAWINGS

Additional features and advantages of the invention will be apparent from the detailed description which follows, taken in conjunction with the accompanying drawings, which together illustrate, by way of example, features of the invention; and, wherein:

FIG. 1a is an illustration of a segmented sign having a weather resistant covering in accordance with an example embodiment of the present invention;

FIG. 1b illustrates a sign segment having a first and second weather resistant covering in accordance with an example embodiment of the present invention; and

FIG. 1c is a side view of a plastic material having an inner corrugation, in accordance with an example embodiment of the present invention.

Reference will now be made to the exemplary embodiments illustrated, and specific language will be used herein to describe the same. It will nevertheless be understood that no limitation of the scope of the invention is thereby intended.

### DETAILED DESCRIPTION OF EXAMPLE EMBODIMENT

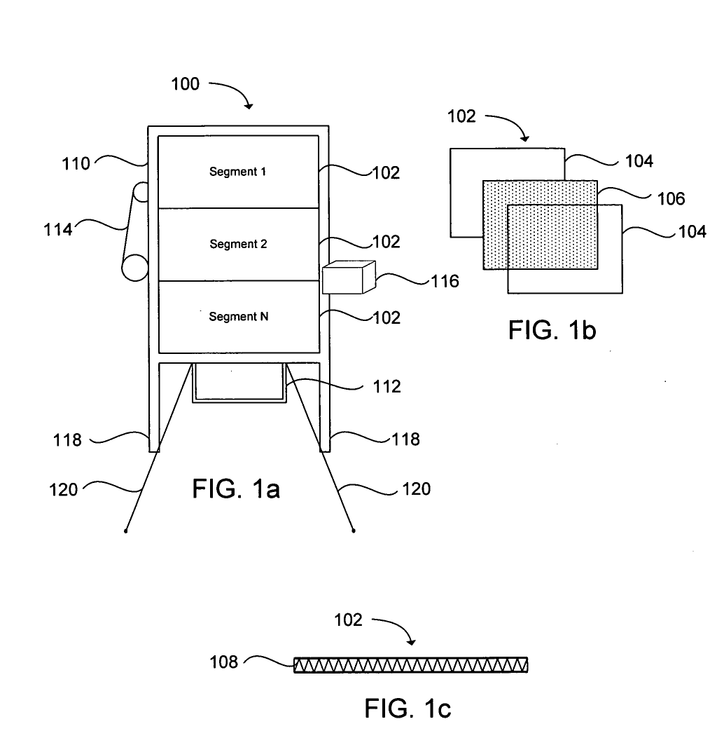

As illustrated in FIG. 1a, a segmented sign system 100, in an example implementation in accordance with the invention, is shown. The segmented sign system can comprise a frame 110. The frame can be configured of angle iron, aluminum, plastic, treated wood, or another material capable of carrying a plurality of sign segments in an outdoor environment. The frame can have a coating configured to minimize wear to the frame. For example, a powder coating can be placed on the frame. A sign placement attachment 112 can be coupled to the frame below the sign and configured to enable a person to position a portion of the frame legs 118 within the ground by placing a foot within the sign placement attachment and pushing down on the frame until a portion of the frame legs have been pushed a desired distance into ground. Guide wires 120 can also be connected to the segmented sign system and staked into the ground a predetermined distance from the sign for added stability. The frame legs shown in FIG. 1 are shown as one example and are not meant to be limiting. The segmented sign system can have any number of legs necessary for support and stability. The frame legs can be formed into any shape or size necessary to support the frame and display the sign at the desired height.

In another embodiment, the frame can have a substantially polygonal shape, wherein the frame does not have any legs. In this embodiment, the frame can be mounted on a wall, fence, building, or other surface which will enable the frame to be properly supported. The frame may also be comprised of a flexible material, such as a flexible plastic or rubber material. Flexible frame materials can allow the frame to be configured in virtually any desired shape. The frames may be reused to display a plurality of different signs.

A plurality of sign segments 102 can be stacked within the frame. In FIG. 1a, the segments are shown having an essentially equal width and height. However, segments of different height and width are possible, as long as the plurality of segments have an overall height and width capable of being securely held within the frame. In one embodiment, the overall segmented sign system 100 can be quite large. After the sign has been erected, the frame can be designed to be lowered using a pulley system or electric motor to enable replacement of the segmented sign system.

Each sign segment 102 can be comprised of an inner layer and one or more outer layers. The inner layer can be comprised of a substantially rigid plastic material 106, as shown in FIG. 1b. In one embodiment, the plastic material can be comprised of corrugated plastic 108 (or corplast) as shown in FIG. 1c. Professional looking graphical and alphanumeric details can be placed on the front and/or back of the plastic material. The graphical and alphanumeric details can be printed in full color. The signs can be printed using a laser printer, screen printing, or another method for placing graphical images upon the plastic material. Colored photographs can be printed on one or more of the sign segments using known printing techniques.

The center layer of the sign can also be created using a vinyl or Mylar which has graphics, photos, or alphanumeric messages. The vinyl can be glued to the transparent protective layers of acrylic or mechanically fastened between the two transparent layers. If the vinyl or Mylar is mechanically fastened between the two layers, this allows the vinyl layer to be replaced when the message on the vinyl or Mylar is desired to be changed. This allows sign owners to recycle or restore the signs if they so desire. For example, the acrylic protective layers can be fastened together (using threaded fasteners, etc.) to hold the vinyl or Mylar that displays the sign message. If desired, a heavy center layer, such as pressed board, can be used to ballast the sign. Using a heavier center layer can offset the lightweight inexpensive materials used for the sign itself.

In addition, this divides the cost of the sign between several layers which can be replaced, recycled or removed. This can be a cost saving to the sign owner over the long run. In addition, each party responsible for a sign segment can directly pay for that sign segment. Another example is where the reusability of the sign allows an owner to divide a cost of manufacturing the sign over the many possible uses (or reuses) of the sign.

In the past, sign costs have not been carried by the individuals who are purchasing the sign. For example, when a real estate agent has purchased a sign for a property, the real estate agent paid for the sign with the real estate agent's own funds. With the present invention, the sign can be divided into sections and each party can be responsible to pay for segments of the signs they are using and for that segment only. For example, a real estate agent may give an owner of a property the opportunity to have a standard sign or the property owner can purchase upgrades to the sign. These upgrades may be based on what standardized layers or segments are available in an upgraded sign. This allows the real estate agent to pay for part of the sign and the property owner to pay for part of the sign. This division also allows the sign cost to be divided by materials in the segments. When there are multiple owners of a sign, each owner can choose different materials for their segment of the sign based on the cost of the material and what the owners want.

A real estate agent can reuse the present invention by replacing segmented components of the sign, which spreads the agent's cost for the sign over many real estate sales. This allows the agent to have customizable sign that is also reusable. For example, each segment can include one or more of the following pieces of real estate information. A real estate sign may include layers or segments for: broker information, agent information, corporation information, seller information, talking/radio sign advertisement information, the presenting agencies information (e.g., multiple listing service IDs), a sponsoring agencies information (e.g., Miracle Network), For Sale notices, For Rent Notices, For Lease notices, property price reduction notices, graphical images, and other real estate related information.

A layer in the present invention is any material that can have message on the layer. The layer can have either one or two sides. If the material is opaque, there is one side that can have a message applied to it. If the material is clear, then the layer has two sides which can have a message applied to it. Multiple transparent layers can be stacked to form the desired sign and message. One or two semi-transparent layers can be used in combination with the transparent layers. The information can be placed upon the sign segment using laser printing, screen printing, decals, imprinting, embossing, impressing or another method for placing graphical images upon the sign segment.

The signs can also use the acrylic or transparent outer layers as a frame which means that the sign will be a frameless acrylic sign. In addition, the sign frame can expand and use inserts to make the frame grow or shrink depending on the number of layers or the size of the layers included in the sign. The sign layers can also be card like where they can be inserted and removed from slots in the frame. There can also be see though windows in layers that would normally be opaque. This allows artwork or messaging from a layer behind another layer to be seen through front layer. This provides peek-a-boo type of windowing in the sign.

The inner layer may also be comprised of a plastic material having magnetic material impregnated therein. The magnetic material can allow magnets and holders to be magnetically coupled to the segmented sign system 100.

The inner layer can be covered on the front and back by one or more outer layers comprising a substantially transparent weather protecting layer 104. The weather protecting layers can comprise acrylic, polyester, Mylar®, Lucite®, glass, or any other material which can allow the sign to be viewed while substantially sealing the sign from the effects of weather. The weather protecting layers can be configured to keep a substantial amount of moisture and dirt from the printed graphical images located on the plastic material. The weather protecting layers can also be formed of a material which will substantially reduce the amount of ultraviolet radiation incident upon the inner plastic material.

Each weather protecting layer 104 can also have graphical and alphanumeric information placed upon it using similar techniques described above. The information can be in color, gray scale, or black and white. The information can be placed upon the weather protecting layer using laser printing, screen printing, decals, or another method for placing graphical images upon the weather protecting material. In another embodiment, the graphical and alphanumeric information may be placed only on the weather protecting layer, leaving the inner substantially rigid plastic material 106 blank. A plurality of weather protecting layers may be coupled to each of the plurality of segments 102, with two or more of the weather protecting layers containing graphical information. For example, a first weather protecting layer may contain alphanumeric information about a sale. A second weather protecting layer may contain graphical information, such as seasonal or holiday graphical images. The second weather protecting layer can be removed and replaced with updated seasonal or holiday graphical images as the seasons change.

Another benefit of the present invention is that it allows signs to be divided into parts where one part of the sign contains “stable” data and graphics that will not be changed frequently. Other parts or segments of the sign can be used for portions of the data that are likely to be modified more frequently. For example, a segment of the sign can contain a real estate agent's cell phone number that might change often or a holiday name that changes each month. Accordingly, changes can be made to the sign without replacing the entire sign. Segmenting the data reduces the cost of the sign and the cost of reusing the sign.

The center layer plastic or corplast material can also be formed into multiple shapes for the sign and the message placed on the sign. The plastic, corplast, or thin vinyl can be cut by a laser or cut by a C-router. Then the protective acrylic layers can be placed over the center section. The protective layers may or may not be cut into the same shape as the center layer.

The graphical and alphanumeric information placed upon the weather protecting layer 104 and/or the inner layer can be cut out using a laser. A piece of flexible plastic material having an adhesive backing can be placed over the weather protecting layer or inner layer. A laser can be used to cut out one or more desired graphical or alphanumeric shapes from a desired position in the piece of flexible plastic material. The remaining flexible plastic material having an adhesive backing can then be removed, allowing the one or more cutout shapes to remain on the weather protecting and/or inner layers at the desired position.

Cutting the shapes out from the flexible plastic material while it is adhered to the weather protecting and/or inner layers can allow the graphical and alphanumeric information to be accurately placed upon the sign segments. Using a laser to cut the graphical and alphanumeric information after the adhesive vinyl or Mylar has been placed on the sign segment can eliminate a step of having to place the cutout information in a proper position after it has been cutout. In addition, vinyl layering can take place by applying a second layer of adhesive vinyl or Mylar over a first layer and then using a laser to cut the vinyl into the desired decal shape. Then the surrounding waste material can be removed and this leaves the decal as a second layer over the first layer. The laser can be used at a relatively low power so that the first decal layer is not damaged. Any number of layers for graphics and lettering can be created using the fast and effective method. In addition, a decal or vinyl line or control line can be used to guide the decal application and determine if vinyl graphics are being appropriately aligned on the layer surface. This decal or vinyl line can be included in the electronic template used to create the decal in order to speed the process of aligning the decal text and images.

In one embodiment the weather protecting layer can comprise a single piece of plastic material. The plastic material can be wrapped around a sign segment 102 and secured. The plastic material may have a composition allowing it to shrink when heated or exposed to ultraviolet radiation. Shrinking the plastic material can enable the material to tightly bind around the sign segment, allowing the plastic material to be nearly invisible. The plastic material may also be printed with graphical information comprising an advertisement prior to the plastic material being wrapped around the sign segment. The pre-printed plastic material can be wrapped around the sign segment and secured in such a fashion that the printed graphical information will be visible.

Each segment 102 can contain at least one piece of information. For example, one segment can contain a company's name. Another segment can contain a company's address. A third segment can contain a company's logo. A fourth segment may contain variable advertising, such as an advertisement for a monthly special. One or more segments may also be left blank. The blank segments may be used as filler to ensure the sign segments fit properly within the frame 110.

Each sign segment 102 can be independently added to or removed from the segmented sign system. For example, one segment may contain a business's phone number and contact information. If a business moves or changes phone numbers, the segment containing the contact information can be removed and replaced with a segment containing the updated information. Segments containing advertisements can also be added and removed, allowing small businesses to continuously update their sign while maintaining its professional appearance. Segments can be removed and have new or different graphical and alphanumeric information placed upon them. For example, as the seasons and holidays change, updated seasonal and/or holiday graphical images can be placed upon the sign segments. Two or more parties can produce a sign together, with each party paying for the sign segments they desire. The plurality of sign segments can be rearranged to fit the changing needs of the sign's owner.

Another type of sign that can be produced using the following method is a yard calendar. The yard calendar may have the name of the individuals or family living at the residence where the yard calendar is to be installed. The yard calendar may also include the street address of the residence or business, artwork, seasonal greetings, a philosophical quote, political support slogans, and other related yard calendar information.

For example, one layer of the sign may include graphics for certain months such as Halloween, Christmas, or New Year's decorations. Another layer of the sign can include the month name and a dated calendar. Alternatively, a seasonal calendar can be provided such as spring, summer, winter and fall. Thus, the layers can be changed but the same sign frame and background layers can be used with the changeable layers. In the past, there have not been any holiday yard signs or yard calendars that have changeable layers or segments. The present invention provides a single frame or design that can be used with interchangeable backgrounds, calendars, graphics and similar sign elements. Since calendars repeat periodically, a number of date calendars can be provided that can be reused periodically in the yard sign.

The segmentation of the signs of the present invention when combined with the reusable frames allows the sign owners to invest in valuable framing for the signs while using less expensive reusable information segments. In particular, segmented sign frames enable the reusable signs to be used by sign owners more effectively. Sign owners can customize the number of frames and the organization of segments which they desire. In addition, the layering of multiple types of materials and the use of multiple sign processes allows less expensive sign materials to be used while still protecting the sign messages from the elements and weather.

Reusability of the signs is valuable aspect of the present invention. In the past, sign makers may have moved a sign from one location to another but sign makers have generally not allowed a weather protected segment to be removed and then replaced with a new message. In addition, sign makers have generally used one type of material to manufacture signs and have not layered their materials. Manufacturers generally use just wood, plastic or metal without combining any layers of materials or processes to make the sign less expensive and recyclable.

Each sign segment can be comprised of different material. For example, one segment may be comprised of the plastic material having magnetic material impregnated therein. Having one sign made of the magnetic material can reduce the overall costs of the sign while enabling external magnetic material to be coupled to the one segment. Each sign segment can have a serial number engraved in order to keep track of the sign segment's materials and construction. This tracking system can enable the segments to be easily replaced. The serial numbers may also enable the segments to be traceable if the segments are stolen.

A strong but inexpensive material can be used as a backing for thin vinyl and Mylar layers. Then the vinyl can be applied to the strong backing such as a clear or opaque vinyl. Then another of clean acrylic or plastic can be applied over the message on the vinyl or Mylar and this will protect the sign message. Multiple clear layers can be arranged to give the sign a feeling of depth for the messages that are printed on any or all of the clear layers.

A public enclosure 114 can be coupled to the frame 110 and used to store information which can be accessed by the public. The public enclosure may comprise a clear container having a lid. The lid can be used to keep the information safe from environmental damage. The clear container can enable the public to see the information stored within the public enclosure. For example, a home owner may use the segmented sign system 100 make a “for rent” or “for sale” sign. The public enclosure can be used to store flyers having more detailed information about the house or rental property, such as pictures of the interior, specifications, sale or rental information, and the like. Persons who are interested in the property can take remove a flyer from the public enclosure.

A private enclosure 116 can be coupled to the frame 110 and used to store information which can only be accessed by persons having permission. The private enclosure may include a keyed entry system, allowing a person having a key to open the private enclosure. The private enclosure can be used to store valuable contents which the sign owner does not want the public to access. For example, a realtor may place a key to a house within the private enclosure. It can also be used for a radio transmitter used to transmit information about a house, rental property, sale, or the like. A battery system can be located within the private enclosure and used to power a plurality of illumination sources, such as LEDs, located on the segmented sign system 100. One or more of the illumination sources can be located either within the frame or outside the frame. The one or more illumination sources can be configured to illuminate one or more of the plurality of sign segments 102. The battery system can be recharged using a solar power electrical source located on the exterior of the frame.

Environmental controls can be incorporated within the segmented sign system 100. For example, a fan or dehumidifier can be used to control humidity between layers of the sign. Alternatively, a sealant can be used to enable the segmented sign system to be substantially sealed to the external environment.

The segmented sign system can enable signs having a professional appearance to be produced at a reasonable cost. A small business owner can use the same sign for a variety of different circumstances by swapping out different sign segments. For example, a realtor can produce a sign having personal information, contact information, and specific information about the property for sale. When the property is sold the sign can be reused at a new property by replacing the sign segment having specific information about the property. The segmented sign system can significantly reduce the amount of money small business owners spend to advertise. Using the segmented sign system, small business owners can advertise more often for a larger number of different occasions, helping them to increase the public's knowledge and, more importantly, increase sales.

The signs discussed herein can also be used for yard sale signs, real estate signs, political campaigning, and similar uses. In the example of political campaigns, the segments can contain the candidate names, party, platform, political office, the election year, election date, graphics, indicia regarding re-election, and similar information. The layering and/or sectioning can be used in a component fashion. For example, the first layer may be a blue field with white stars on it. The second clear layer may include the candidates name and the third layer may include the party name. This allows the artwork and other information to be re-used. When a candidate is going for re-election the same artwork and name layer can be used and just one layer can be replaced.

The layering allows the sign frames, letter layers and artwork layers to be leased to customers and then the customer can purchase a layer that includes the modified message and/or graphics. This applies to real estate signs, rental signs, campaign signs, and other signs that can be reused. Not only does this reduce the costs of signs but it allows the signs to be more effectively recycled, restored or refurbished. Being able to reuse and recycle sign components also protects the environment because less overall waste is created. In the past, purchasers of signs have discarded entire signs because they are no longer useable. The present invention helps overcome this problem of signs that are discarded after just one use.

In addition to leasing portions of the sign and selling other portions of a sign, an entire completed sign can be leased. Fully assembled signs can be leased to individuals who desire a sign that does not need any changes. For example, a pre-assembled sign can include the elements of a “Grand Opening”, Seasonal Sale, or similar generic signs. If the customer leasing the sign desires to customize the sign, then additional layers can be added to the sign in order to make changes to the sign.

Not only can the sign frame and components be leased but space on the sign or layers with certain messages can be leased. For example, if a sign owner has a permanent sign in a good advertising location, then segments of the sign can be replaced with new updated advertising segments. This allows the layers of the segments to be updated with advertising material and the sign owner can lease either layers or segments of the sign.

Another example of leasing is where the customer leases a layer with a pre-printed message such as “[blank] Acres for Sale” and another purchased clear layer can contain the number of acres “99” printed on it. When the two layers are combined, it will read as “99 acres for sale”. This is possible because of the template produced to match up the leased and customized parts of the messages. When the customer has sold the property, then customer can return the leased message and another customer can purchase a layer with a different number acres to be sold. This also system and method also applies to graphics or photos.

A software management system can accompany the present signing system and method. The software can manage the identification tracking numbers on the signs. These identification tracking numbers are used to drive the leasing and re-furbishing program. In addition, the tracking number can be used to track theft of the signs. When the sign are leased, a reward sticker can be placed on the signs to indicate that a reward will be paid for individuals who return stolen or lost signs. Another feature of the software can manage the leasing inventory including the sign frames, the leasing terms and the sign segments that are rentable or leasable. A Global Positioning System (GPS) tracking device can also be used with the sign to deter the theft of expensive signs or leased signs.

The layering described for the present invention can be setup in any number of layers. Only the sign frame or attachments to frame may limit the number of layers. Further, the present invention can use N layers by M segments as desired by the purchaser of the sign. Although the example of the sign in the drawings illustrates the segments being stacked in a vertical fashion, the segments may also be created in a horizontal direction or in a two-dimensional irregular grid.

The implementation of reusable signs in the present invention also allows old signs to be consigned to a sign shop for refurbishing and/or resale. The reusable frames and many of the reusable components such as the frames, artwork, sections, and layers can be re-sold, traded, pawned, sold for refurbishing, or otherwise sold.

Because these signs can be recycled or refurbished, this allows standard sizing to be developed for the signs. When standard frame sizing is used, then standard layers sizes can be generated for the signs. The standardization of the sign layers can reduce the cost of the overall sign because sign purchasers can enter a sign shop and buy a number of pre-produced layers with graphics and backgrounds. Then these standardized layers can be used with customized layers to produce less expensive but useful signs.

Standard sign sizing also results in efficiencies in generating the signs and cost standardization. Computer templates can be used that are set to the standard frame and sign sizes. When a customer desires to have a new sign to be manufactured then the customer can select a template to be used. This template can be used to generate the graphics, lettering and other indicia on the sign. For example, the sign can be generated with the templates using laser etching, engraving, or silk screening. Each template can be assigned a cost and this provides a uniform cost for the sign generation. These templates can be used to provide any layer or segment of the signs. Using a sign template reduces the setup and labor costs associated with producing the sign.

Another valuable aspect of the present invention is that the invention combines mass-assembly techniques with customizations that are typically needed in so many signs. Because the present invention can pre-fabricate many of the sign parts, this reduces the overall sign cost. Then the end customer can customize just one or two layers that are needed and only pay for that customization while retaining the cost reductions of the mass-produced items.

For instance, signs can be manufactured in a number of standardized configurations that include a pre-determined number of legs, standard finishes and sealants, sign segments or sections, and the frame will be preconfigured to hold 1-N sign layers. As discussed above, the sign layers can be acrylic, corplast, and similar materials. The layers can be fastened into the frame with metal or plastic fasteners. The frame, layers and printed materials can be standardized as far as possible to obtain the benefits of economy of scale. In addition, these frames can have standardized locations for the adding of sign accessories. These accessories are similar to those as described before such as talking sign attachments, lights, motors, etc. Since the signs of the present invention are less expensive than entirely custom produced signs, this allows the customer to purchase more accessories.

This combination of pre-assembled signs allows a customer to pick a sign from the a showroom and then immediately combine their own customized elements with the pre-made elements.

The present invention can also be used to enhance billboard signs. Current billboard signs are printed one time and then fixed to the billboard. After this one time printing the billboard cannot be modified without removing the entire printed sign. The present invention provides a segmented sign that can use an attached motor to bring down a section of a billboard sign and replace it. This allows the owner of the sign to change prices, merchandise volume amounts or any other information contained on the sign.

In another embodiment of the sign, a drainage system can be provided for the segmented sign. The drainage system can include a drainage channel that is in or on the sign to drain away excess rain or other moisture. A drainage pipe can be connected to the drainage channel through the sign's frame. The drainage pipe can also be configured to support the segmented sign in the ground. In addition, a receiving base can be provided that is configured to be mounted into the ground. In other words the receiving base can be a cement block that is set into the ground or the receiving base can be a metal sleeve that is cemented into the ground. The receiving base can receive the drainage pipe and include a drain to allow water to pass from the drainage pipe to the ground. A layer of gravel can located under the concrete for the water to drain into from the sign. This drainage system keeps the sign dry and can also avoid the rotting or water damage that has existed with wood and other signs.

A metal loop can be located on the segmented sign frame or drainage pipe and another metal loop can be located on the receiving base to enable the segmented sign to be locked to the receiving base. If the sign is not locked in place then vandals may be able to remove the sign from the drainage system. The drainage system can double as a removable sign base. In other words, the signs can be interchanged at the same site using minimal installation procedures once the receiving base has been installed. Alternatively, the drainage pipe can be welded to the metal sleeve into which the drainage pipe is mounted.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. A weather protected segmented sign system, comprising:
a frame configured to hold a plurality of sign segments, the plurality of sign segments comprised of a substantially rigid plastic material, each sign segment configured to be stackable within the frame and independently removable from the frame;
each of the plurality of sign segments configured to accept graphical and alphanumeric images carried upon one or more faces of the plurality of sign segments;
the plurality of sign segments each having a front side and a back side essentially covered with one or more substantially transparent weather protecting layers, the one or more weather protecting layers configured to enable each sign segment to be essentially undamaged by weathering effects for a period of years; and
each of the one or more weather protecting layers further configured to accept graphical and alphanumeric images carried upon an interior face.

2. A segmented sign system as in claim 1, wherein the frame is formed of a weather resistant material selected from the group consisting of angle iron, aluminum, plastic, wood, marble, stone, cultured stone, concrete, man-made material, metals, rubber, concrete compounds, stainless steel, and a mixture of materials from the group of weather resistant material.

3. A segmented sign as in claim 1, wherein the frame is anchored into a heavy material selected from the group consisting of concrete, stone and metal.

4. A segmented sign as in claim 1, wherein the frame is assembled by welding, joint assembly, or spot welding.

5. A segmented sign as in claim 1, wherein the frame and sign are pre-fabricated.

6. A segmented sign as in claim 1, wherein one or more of the plurality of sign segments are sealed together to form a single unit.

7. A segmented sign as in claim 6, wherein a portion of sign segments are sealed and the remainder are layered in the sign.

8. A segmented sign system as in claim 1, wherein the frame is substantially covered with a powder coating to minimize weathering to the frame.

9. A segmented sign system as in claim 8, wherein the frame is embossed, sandblasted, or engraved.

10. A segmented sign system as in claim 1, further comprising sign decorations and sign messaging on the sign frame.

11. A segmented sign system as in claim 1, wherein each of the sign segments in the sign have information printed on both sides of a layer of the sign segment.

12. A segmented sign system as in claim 1, wherein a plurality of message application processes is used on both sides of a transparent sign segment.

13. A segmented sign system as in claim 12, wherein the message application process can be processes selected from the group consisting of printing, engraving, silk screening, decaling, and routing.

14. A segmented sign system as in claim 1, wherein the message application process can use a plurality of message application processes, a plurality of manufacturing techniques and a plurality of various materials.

15. A segmented sign system as in claim 1, further comprising a sign placement attachment coupled to the frame and configured to allow a person to place their foot in the sign placement attachment and drive the segmented sign system into a piece of ground a sufficient distance to support the segmented sign system.

16. A segmented sign as in claim 1, wherein the sign segments and frame can be made from treated wood, treated concrete, or treated manmade material.

17. A segmented sign system as in claim 1, further comprising one or more guide wires coupled to the frame and configured to be attached to the ground around the frame to add stability to the segmented sign system.

18. A segmented sign system as in claim 1, wherein one or more of the plurality of sign segments can have a different size than a remaining plurality of sign segments.

19. A segmented sign system as in claim 1, wherein each of the plurality of sign segments have a substantially equal size.

20. A segmented sign system as in claim 1, wherein the graphical and alphanumeric images comprise one or more colors.

21. A segmented sign system as in claim 1, wherein at least one of the plurality of sign segments has pre-printed information that is selected by a user and at least one of the plurality of sign segments has customizable data that is added by the user after the segmented sign system is manufactured.

22. A segmented sign as in claim 21, wherein the segments with pre-printed information include stable data that does not change in the sign and the remaining segments contain non-stable data to be customized in the sign.

23. A segmented sign system as in claim 1, wherein one or more of the plurality of sign segments comprise plastic material having magnetic material impregnated therein to allow magnets to be attached to the one or more sign segments.

24. A segmented sign system as in claim 1, wherein one or more of the plurality of sign segments are comprised of different materials than a remaining plurality of sign segments.

25. A segmented sign system as in claim 1, wherein the substantially rigid plastic material is comprised of a corrugated plastic material.

26. A segmented sign system as in claim 1, wherein the one or more weather protecting layers are comprised of a substantially transparent material selected from the group consisting of acrylic, polyester film, glass, Lucite®, and Mylar®.

27. A segmented sign system as in claim 1, wherein the one or more weather protecting layers are configured to accept graphical and alphanumeric images carried upon one or more faces of each of the one or more weather protecting layers.

28. A segmented sign system as in claim 1, wherein at least one of the one or more weather protecting layers have graphical and alphanumeric images carried upon it and the plurality of sign segments within the one or more weather protecting layers are substantially blank.

29. A segmented sign system as in claim 1, further comprising an accessories receiver configured to receive accessories to the segmented sign system.

30. A segmented sign system as in claim 29, further comprising accessories that can be attached to the accessories receiver, the accessories selected from the group consisting of: lights, additional sign holders, motors, flags, banners, decorative knobs, brochure holders, a lock box, and electronic components.

31. A segmented sign system as in claim 29 wherein the banner has a clear protective coat of resin over the banner.

32. A segmented sign system as in claim 29 wherein a vinyl banner is a center layer.

33. A segmented sign system as in claim 1, further comprising a public enclosure coupled to the frame and configured to distribute information to interested persons.

34. A segmented sign system as in claim 1, further comprising a private enclosure coupled to the frame and configured to store information which can only be accessed by persons having permission to do so.

35. A segmented sign system as in claim 34, wherein the private enclosure is configured to store one or more items selected from the group consisting of a key, a radio transmitter, a battery, and private information.

36. A segmented sign system as in claim 1, further comprising one or more illuminant sources coupled to the frame and configured to illuminate one or more of the plurality of sign segments.

37. A segmented sign system as in claim 36, wherein at least one of the one or more illuminant sources is located inside the frame.

38. A segmented sign system as in claim 1, wherein the illuminant sources are solar powered lighting.

39. A segmented sign system as in claim 1, wherein the segmented sign system can have a plurality of attachment holders.

40. A segmented sign system as in claim 1, wherein weather protecting layers further comprises a plurality of weather protecting layers that have messaging on one or more of the layers.

41. A segmented sign system as in claim 1, wherein the sign segments can have multiple layers.

42. A segmented sign system as in claim 1, wherein the sign segments are vinyl without adhesive in order to allow the sign segments to be replaced by a user.

43. A segmented sign system as in claim 42, wherein the vinyl can be supported by a stiff backing.

44. A segmented sign system as in claim 43, wherein the stiff backing is construction paper, pressed wood, wall paper, poster board, cardboard, or corplast.

45. A segmented sign system as in claim 43, wherein the stiff backing is a matteboard.

46. A segmented sign system as in claim 45, wherein the vinyl can be applied to the matteboard with adhesive.

47. A segmented sign system as in claim 1, wherein one or more of the plurality of sign segments is cut into an arbitrary sign segment shape and a framing is provided to border the arbitrary sign segment shape.

48. A segmented sign system as in claim 47 wherein the framing is comprised of a soft molding or rubber that can be conformed to the arbitrary sign segment shape.

49. A segmented sign system as in claim 1, wherein the plurality of sign segments have identifying serial numbers to deter theft of the plurality of sign segments.

50. A segmented sign system as in claim 1, wherein one or more of the plurality of sign segments are comprised of two layers of corrugated plastic that are adhered together with a metal post between the two layers to support the segmented sign system.

51. A segmented sign system as in claim 1, that allows purchasers of a sign to prorate a cost of the sign between multiple individuals who need to use the sign.

52. A segmented sign as in claim 51, wherein the prorating can be divided by sign layer, sign section, or sign usage.

53. A segmented sign system as in claim 1, wherein an individual desiring to use a sign can lease, pawn, trade, recycle, or finance payments for the sign.

54. A segmented sign system as in claim 1, further comprising an electronic template sized to match a sign segment, wherein the electronic template can be used to create message data to be applied to the sign segments as vinyl decals.

55. A segmented sign system as in claim 54, further comprising a control line included on the template to align the vinyl decal message data, wherein the control line is applied with the vinyl decal to align the message data.

56. A segmented sign system as in claim 1, further comprising a drainage system for the segmented sign, comprising:
a drainage channel in the sign;
a drainage pipe connected to the drainage channel, the drainage pipe configured to support the segmented sign in ground; and
a receiving base configured for being mounted in the ground and for receiving the drainage pipe, wherein the receiving base contains a drain to allow water to pass from the drainage pipe to the ground.

57. A segmented sign system as in claim 1, further comprising a metal loop on the segmented sign and a metal loop on the receiving base to enable the segmented sign to be locked to the receiving base.

58. A method for protecting an advertising sign from weathering conditions comprising:
providing a frame configured to hold a plurality of sign segments, the sign segments having a front side and a back side, the sides each configured to carry graphical and alphanumeric images;
covering the front and back sides of each of the plurality of sign segment with one or more substantially transparent coverings configured to enable each sign segment to be essentially undamaged by weathering effects for a period of years;
placing the plurality of segments within the frame; and
enabling one or more of the plurality of sign segments to be removed from the frame and replaced with one or more segments having a substantially similar size as the one or more removed segments.

59. A method as in claim 58, further comprising the step of pre-assembling the sign and providing attachment points for modular components.

60. A method as in claim 58, further comprising the step of providing a kit for assembly of the sign containing the frame, sign segments, fasteners, and protective coverings.

61. A method as in claim 58, further comprising the step of providing a kit for assembly of the sign containing the frame, sign segments, fasteners, protective coverings, sign accessories, sign printing instructions, sign identification bar codes, and a layer with a sign message.

62. A method as in claim 59, further comprising the step of attaching modular components to the sign using fasteners, adhesive, hooks, welding, or another attachment method.

63. A method as in claim 58, further comprising the step of enabling the modular components to be detached and rearranged.

64. A method as in claim 58, further comprising the step of using motors on the sign in order to add and remove large segments of the sign.

65. A method as in claim 58, further comprising the step of using motors on the frame to drive accessories.

66. A method as in claim 58, further comprising the step of supplying a new sign segment to replace a sign segment between the one or more substantially transparent coverings in order to enable a remainder of the sign to be reused.

67. A method as in claim 58, further comprising the step of supplying a hanging sign segment and holes in the bottom of the sign frame to enable the hanging sign segment to be hung from the bottom of the frame.

68. A method as in claim 58, further comprising the step of manufacturing the frame and the transparent protective coverings made of acrylic by cutting the frame and transparent protective coverings with a plasma laser.

69. A method as in claim 68, further comprising the step of assembling the frame by screwing the frame together.

70. A method as in claim 68, further comprising the step of cutting sign supports with a plasma laser cutter and screwing the sign supports together with the frame.

71. A method as in claim 68, further comprising the step of printing messaging and graphics on the sign segments which are assembled in to the sign using screws.

72. A method as in claim 58, further comprising the step of determining the cost for the advertising sign by calculating the material cost, welding cost by a number of joints, painting costs and printing costs by the inch.

73. A weather protected segmented yard sign system, comprising:
a frame configured to hold a plurality of sign segments, the plurality of sign segments comprised of a substantially rigid plastic material, each sign segment configured to be stackable within the frame and independently removable from the frame;
each of the plurality of sign segments configured to accept graphical and alphanumeric yard art images carried upon one or more faces of the plurality of sign segments;
the plurality of sign segments each having a front side and a back side essentially covered with one or more substantially transparent weather protecting layers, the one or more weather protecting layers configured to enable each sign segment to be essentially undamaged by weathering effects for a period of years; and
each of the one or more weather protecting layers further configured to accept graphical and alphanumeric yard art images carried upon an interior face.

74. A segmented sign system as in claim 72, wherein each of the plurality of sign segments is removable in order to allow a sign segment to be replaced with a different sign segment.

75. A segmented sign system as in claim 72, wherein the yard art images on the one or more weather protecting layers are selected from the group consisting of holidays, seasons, family events, flags, and home business messages.

76. A segmented sign system as in claim 72, wherein the yard art images on the one or more weather protecting layers includes a message selected from the group consisting of a name, address number, and company name.

75. A segmented sign system as in claim 72, wherein the segmented sign system combines a radio message section, a real estate company name, and real estate agent name.

76. A segmented sign system as in claim 72, wherein the segmented sign system includes messages selected from the group consisting of political candidate names, political party, platform, political office, the election year, election date, graphics, indicia regarding re-election.

77. A weather protected segmented sign system, comprising:
a frame configured to hold a plurality of sign segments, the plurality of sign segments comprised of a substantially rigid plastic material, each sign segment configured to be stackable within the frame, independently removable from the frame, wherein one or more of the plurality of sign segments is cut into a freeform shape;
each of the plurality of sign segments configured to accept graphical and alphanumeric yard art images carried upon one or more faces of the plurality of sign segments, the sign segments each having a front side and a back side essentially covered with one or more substantially transparent weather protecting layers, the one or more weather protecting layers configured to enable each sign segment to be essentially undamaged by weathering effects for a period of years; and
each of the one or more weather protecting layers further configured to accept graphical and alphanumeric yard art images carried upon an interior face, wherein one or more of the weather protecting layers are cut into the same freeform shape as one or more of the sign segments.

78. A weather protected segmented sign system as in claim 77, wherein the sign frame is cut into a shape that can accept the freeform shape.

79. A weather protected segmented sign system as in claim 77, wherein the sign frame is cut into a shape that is a fanciful character or business logo.

80. A method for refurbishing a used sign, comprising the steps of:
receiving a used sign frame and sign body;
replacing portions of the sign body with new sign segments and layers;
placing the plurality of portions within the used sign frame;
covering the sign body with one or more substantially transparent coverings configured to enable each sign segment to be essentially undamaged by weathering effects for a period of years; and
enabling one or more of the plurality of sign segments to be removed from the frame and replaced with one or more segments having a substantially similar size as the one or more removed segments.

81. A method as in claim 80, further comprising the step of supplying a new sign segment to replace a sign segment between the one or more substantially transparent coverings in order to enable a remainder of the sign to be reused.

82. A segmented sign system as in claim 80, further comprising a soft frame that can conform to the freeform shape, the soft frame being selected from the group consisting of rubber, glue, metal molding, plastic molding, and foam.

83. A segmented sign system as in claim 80, further comprising a plurality of fasteners use to hold the substantially transparent layers in place, wherein a rigid frame does not need to be used.

84. A method for leasing a layered sign, comprising the steps of:
manufacturing a layered sign having sign segments and sign protection layers;
selecting a plurality of layers that can be reused in the layered sign;
leasing the layered sign by combining the plurality of reusable layers;
replacing at least one of the sign segments; and
re-leasing the layered sign.

85. A method for leasing a layered sign as in claim 84, further comprising the step of enabling a user to lease a layer with pre-printed verbage to be incorporated in the sign.

86. A method for leasing a layered sign as in claim 84, further comprising the step of enabling a user to lease a layer with pre-printed generic verbage to be incorporated in the sign.

87. A method for leasing a layered sign as in claim 84, further comprising the step of enabling a user to lease a segment or section of a sign.

88. A method for leasing a layered sign as in claim 84, further comprising the step of enabling a user to lease a sign frame.

89. An electronic system for leasing a layered sign, comprising:
a sign tracking software module, configured to generate sign tracking numbers for sign frames and sign segments
a sign tracking database configured for storing tracking numbers for the sign frames and segments;
a library module, configured to allow users to check-in or check-out the sign frames and segments that have been leased; and
a storage tracking module to track where signs are stored in a physical warehouse space.
